(19) United States
(12) Patent Application Publication
(10) Pub. No.: US 2026/0301343 A1
(43) Pub. Date: Oct. 1, 2026

(54) ITEM PROVIDING SYSTEM

(71) Applicant: NTT DOCOMO, INC., Tokyo (JP)

(72) Inventor: Motokazu YOSHIZAWA, Tokyo (JP)

(73) Assignee: NTT DOCOMO, INC., Tokyo (JP)

(21) Appl. No.: 19/491,016

(22) PCT Filed: Sep. 2, 2024
(86) PCT No.: PCT/JP2024/031476

§ 371 Date: Dec. 8, 2025

(30) Foreign Application Priority Data
Sep. 4, 2023 (JP) 2023-143049

(51) Int. Cl. G06T 19/20; G10L 15/26

(52) U.S. Cl. CPC G06T 19/20; G10L 15/26

(57) ABSTRACT

An item providing system for providing items in a virtual space comprises: an instruction acquisition unit configured to acquire a generation instruction including type information indicating an item type from a user; a standard data acquisition unit configured to acquire standard data of an item indicated in the type information; an input information generation unit configured to generate input information including information extracted from user information unique to the user according to a given extraction criterion; a prompt output unit configured to output prompt information including the standard data and the input information to an item generation system; and an item possession unit configured to associate the generation item generated by the item generation system with the user.

### TECHNICAL FIELD The present invention relates to an item providing system.

### BACKGROUND ART

In recent years, services in which a user can engage in various experiences including communicating with other users and the like by acting as an avatar in a virtual space such as the so-called metaverse have been provided. In the virtual space, as in the real space, it is possible to produce objects and possess and use the produced objects. As one example, a technique in which a clothing model desired to be worn by an avatar can be selected and the selected clothing model can be applied as a texture to the avatar is known (see, for example, Patent Literature 1).

### CITATION LIST

### Patent Literature

[Patent Literature 1] Japanese Unexamined Patent Publication No. 2016-61477

### SUMMARY OF INVENTION

### Technical Problem

For users who enjoy services in virtual spaces, there is a demand not only to select an item from items prepared in advance, but also to have an avatar possess and use items unique to the user.

Accordingly, an objective of the present invention is to provide an avatar, which acts in a virtual space, with items unique to the user.

### Solution to Problem

In order to solve the above problems, according to an aspect of the present disclosure, there is provided an item providing system for providing items to be possessed, used, and/or utilized by a user in a virtual space, the item providing system comprising: an instruction acquisition unit configured to acquire a generation instruction for the items from the user, the generation instruction including type information indicating an item type; a standard data acquisition unit configured to acquire previously stored standard data constituting an item indicated in the type information; an input information generation unit configured to generate input information including information extracted from user information unique to the user, associated with the user, according to a given extraction criterion; a prompt output unit configured to output prompt information for inputting the standard data and the input information to an item generation system, the item generation system generating a generation item that is an item configured based on the standard data in accordance with the input information, in accordance with an input of the prompt information; and an item possession unit configured to associate the generation item generated by the item generation system with the user.

According to the above-described aspect, the input information to be input to the item generation system is generated based on user information. Because the user information is unique to the user, the input information is also unique to the user. Because the generated input information and the standard data are output as the prompt information to be input to the item generation system, the item generation system can generate the generation item. By associating the generation item with the user, it is possible to provide the user's avatar with a generation item unique to that user.

### Advantageous Effects of Invention

It is possible to provide an avatar, which acts in a virtual space, with items unique to a user.

### BRIEF DESCRIPTION OF DRAWINGS

FIG. 1 is a block diagram showing a functional configuration of a virtual space management system including an item providing system of the present embodiment and a virtual space management device.

FIG. 2 is a diagram schematically showing an example of standard data stored in a standard data storage unit.

FIG. 3 is a diagram showing an example of user attribute information stored in a user attribute information storage unit.

FIG. 4 is a diagram schematically showing an example of utterance history information stored in an utterance history information storage unit.

FIG. 5 is a diagram showing an example in which input information to be included in prompt information is generated.

FIG. 6 is a diagram schematically showing the generation of a generation item by the item generation system.

FIG. 7 is a diagram schematically showing a configuration of a generation item storage unit and stored generation items.

FIG. 8 is a flowchart showing processing content of an item providing method in the item providing system.

FIG. 9 is a diagram showing a configuration of an item providing program.

FIG. 10 is a hardware block diagram of an item providing device (virtual space management device).

### DESCRIPTION OF EMBODIMENTS

An embodiment of an item providing system according to the present invention will be described with reference to the drawings. Where possible, the same reference signs are assigned to the same parts, and redundant descriptions will be omitted.

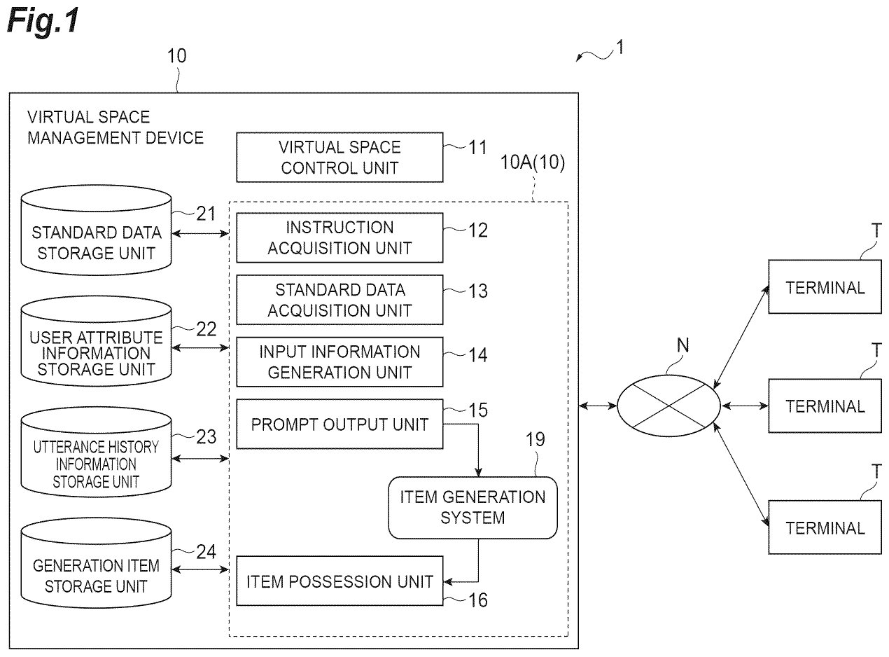

FIG. 1 is a block diagram showing a functional configuration of a virtual space management system including an item providing system according to the present embodiment and a virtual space management device. A virtual space management system 1 is a system for managing a virtual space, such as, for example, the so-called metaverse, constructed on a network, and is configured to include a virtual space management device 10 as an example. As shown in FIG. 1, the virtual space management system 1 includes the virtual space management device 10 and a user terminal T. By accessing an item providing system 10A via a network N with the terminal T, the user can cause the user's avatar to act in the virtual space. The item providing system 10A of the present embodiment is a system that provides items to be possessed, used, and/or utilized by a user in the virtual space, and is configured, for example, as a partial function of the virtual space management system 1.

As shown in FIG. 1, the virtual space management device 10 functionally includes a virtual space control unit 11, an instruction acquisition unit 12, a standard data acquisition unit 13, an input information generation unit 14, a prompt output unit 15, and an item possession unit 16. The item providing system 10A includes the instruction acquisition unit 12, the standard data acquisition unit 13, the input information generation unit 14, the prompt output unit 15, and the item possession unit 16. The prompt output unit 15 and the item possession unit 16 are configured to be able to access an item generation system 19. Although the item generation system 19 is included in the item providing system 10A in the present embodiment, the item generation system 19 may be configured outside the item providing system 10A. Each of the functional units 11 to 16 may be configured in a single device as exemplified in FIG. 1, or may be distributed across a plurality of devices.

Each functional unit of the item providing system 10A is configured to be able to access a standard data storage unit 21, a user attribute information storage unit 22, an utterance history information storage unit 23, and a generation item storage unit 24. The standard data storage unit 21 is a storage means (storage) that stores standard data. The user attribute information storage unit 22 is a storage means that stores user attribute information. The utterance history information storage unit 23 is a storage means that stores utterance history information. The generation item storage unit 24 is a storage means for storing generation items.

As exemplified in FIG. 1, the standard data storage unit 21, the user attribute information storage unit 22, the utterance history information storage unit 23, and the generation item storage unit 24 may be configured in the same device in which the item providing system 10A is configured or may be configured in a separate device that is accessible by the item providing system 10A.

Next, various functional units of the virtual space management device 10 and the item providing system 10A will be described. The virtual space control unit 11 manages the virtual space. Specifically, the virtual space control unit 11 defines and models a three-dimensional virtual space, and arranges various types of objects, user avatars, and the like in the virtual space based on respective control information. Moreover, the virtual space control unit 11 provides the terminal T with images rendered based on a viewpoint (virtual camera) of the avatar.

The instruction acquisition unit 12 acquires a generation instruction for an item from a user. The generation instruction indicates a request to generate an item from the user in the virtual space management system. The item is an object to be possessed, used, and/or utilized by the user or the user's avatar in the virtual space. Although the item is not limited to any particular object as long as it is such an object, in the present embodiment, the item is, for example, clothing. Hereinafter, in the present embodiment, an example in which the item is clothing will be described.

Specifically, the instruction acquisition unit 12, for example, receives and acquires a generation instruction based on an input of the user at the terminal T. The generation instruction may also be issued in an aspect in which it is uttered by the user's avatar in the virtual space.

The generation instruction includes type information indicating an item type. When the item is clothing, the type information may be information indicating one of clothing types such as a shirt, pants, or a hat.

The standard data acquisition unit 13 acquires previously stored standard data constituting an item indicated in the type information. Specifically, the standard data acquisition unit 13 may acquire standard data from the standard data storage unit 21.

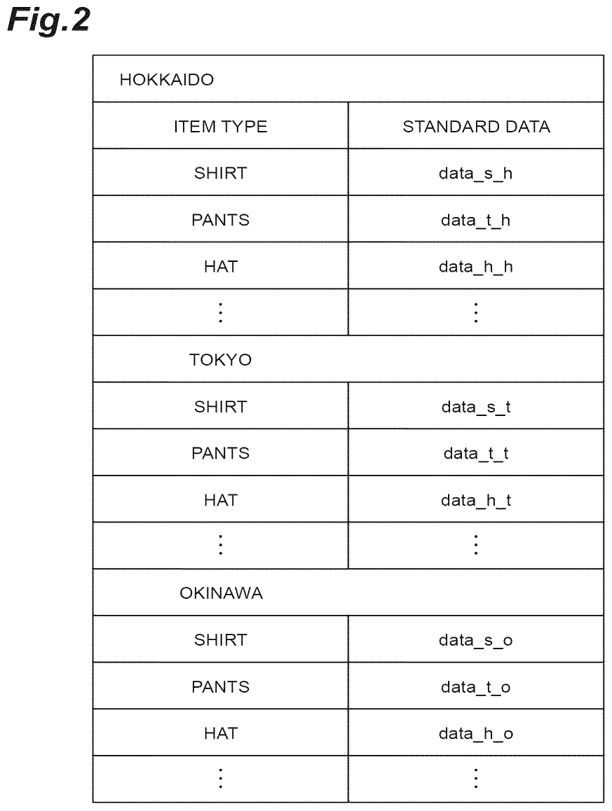

FIG. 2 is a diagram schematically showing an example of a configuration of the standard data storage unit 21 and data stored therein. As shown in FIG. 2, the standard data storage unit 21 stores standard data associated with item types indicating clothing types such as shirts, pants, and hats.

The standard data may be data constituting the shape of an item. For example, standard data “data s h” associated with the item type “shirt” may be data constituting the shape of a shirt or may be point cloud data constituting the shape of the shirt. In this case, the standard data may be data that does not include information such as colors or patterns.

Moreover, the standard data may be associated with respective regions in the virtual space. In the example shown in FIG. 2, the standard data storage unit 21 stores standard data for each item type in each of the regions such as Hokkaido, Tokyo, and Okinawa. In this case, the standard data acquisition unit 13 acquires the location of the user's avatar in the virtual space and acquires the standard data associated with the region to which the location belongs. Although an aspect in which the standard data for each region is stored in one database is shown in the example of the standard data storage unit 21 shown in FIG. 2, an aspect in which the standard data of each region is stored in a separate database for each region may be provided.

When a generation instruction including type information “shirt” is acquired from an avatar located at a position corresponding to Tokyo in the virtual space, the standard data acquisition unit 13 acquires the standard data “data_s_t” associated with the item type “shirt” for the region “Tokyo” from the standard data storage unit 21.

The input information generation unit 14 generates input information including information extracted from user information associated with the user and unique to the user, according to a given extraction criterion. The input information is information to be input to the item generation system, as will be described below in detail.

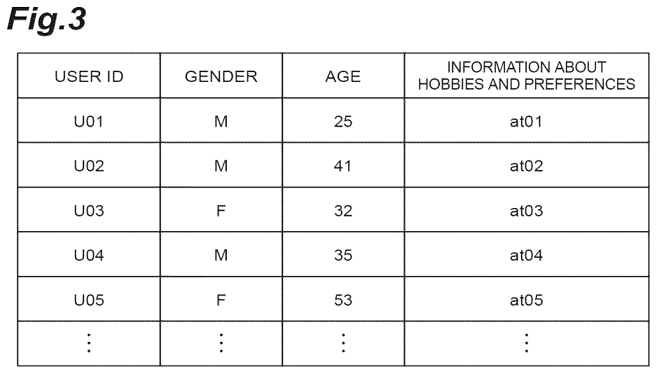

The user information may be user attribute information indicating attributes of the user. FIG. 3 is a diagram showing an example of user attribute information stored in the user attribute information storage unit 22. As exemplified in FIG. 3, the user attribute information storage unit 22 stores, as the user attribute information, information indicating gender, age, hobbies, and preferences of each user in association with a user ID for identifying the user.

The user attribute information storage unit 22 may be configured as one function of a so-called urban OS. The urban OS is basic software for a city and is a software platform for operating application software in fields such as administration, logistics, and transportation. With the urban OS, information cooperation with other municipalities, companies, and research institutions can be achieved, and the provision of services optimized for residents can be implemented.

Moreover, the user attribute information storage unit 22 may be configured to acquire and store user attribute information managed by the urban OS. In this way, by referencing or acquiring user attribute information managed by the urban OS, even if the user moves between cities, the item providing system 10A of the present embodiment can acquire appropriate user attribute information.

The input information generation unit 14 may generate input information including attribute information extracted from the user attribute information, using the extraction of attribute information of a predetermined attribute item among a plurality of attribute items included in the user attribute information as an extraction criterion. For example, when the extraction criterion is to extract information about hobbies and preferences from the user attribute information, the input information generation unit 14 extracts and acquires hobby/preference information “at01” from the attribute information associated with user ID “U01” in accordance with a generation instruction from user ID “U01” and generates input information including the acquired information “at01.”

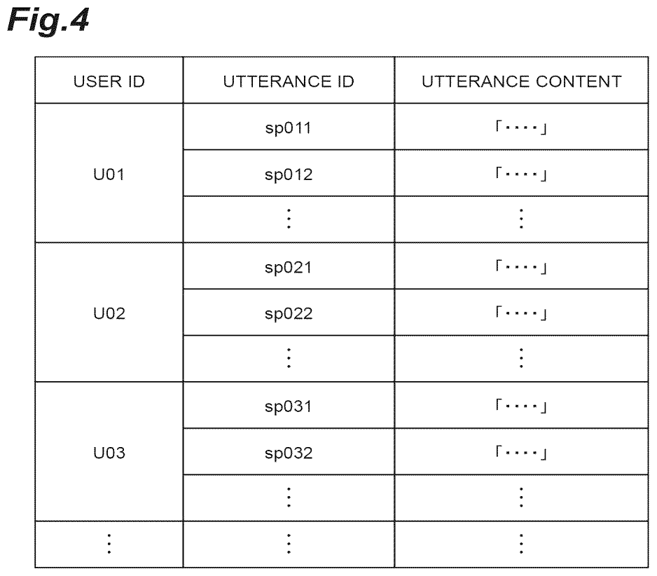

The user information may also be utterance history information, which is a history of utterances of the user's avatar in the virtual space. FIG. 4 is a diagram schematically showing an example of utterance history information stored in the utterance history information storage unit 23. As exemplified in FIG. 4, the utterance history information storage unit 23 stores, as utterance history information, utterance content associated with a user ID for identifying the user and an utterance ID for identifying the utterance history.

The input information generation unit 14 may generate input information based on utterance history information, using the extraction of related words preset as words related to the item as an extraction criterion. For example, the extraction criterion may be to extract a keyword “clothing” related to the item from the utterance history, acquire a given number of sentences around the keyword (e.g., a preset number of characters or sentences before and after the keyword) from the utterance history as an input part, and extract, from words obtained by morphological analysis of input text that has been acquired, words excluding particles, auxiliary verbs, and the like, as information to be included in the input information.

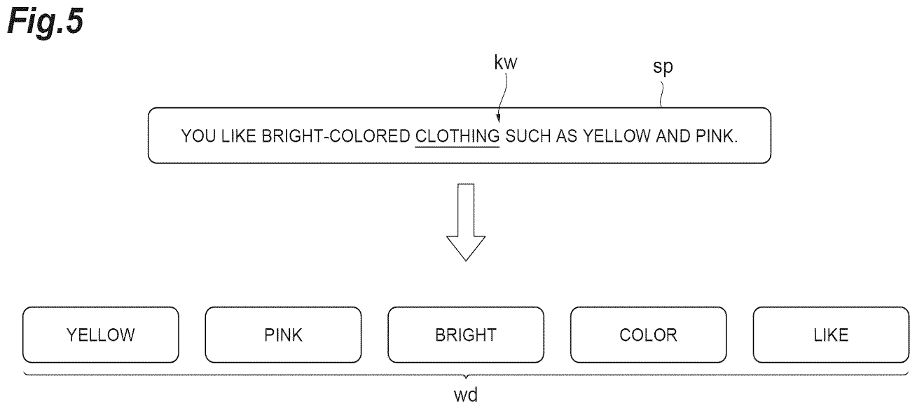

FIG. 5 is a diagram showing an example of a part of a process for generating input information. In the example shown in FIG. 5, the input information generation unit 14 extracts, from utterance history information of a target user stored in the utterance history information storage unit 23, a keyword kw representing the item, namely “clothing,” and, for example, acquires a sentence sp including the keyword kw “clothing.” Also, the input information generation unit 14 performs morphological analysis on the sentence sp and acquires, as words wd to be included in the input information, predetermined independent words other than particles and auxiliary verbs.

The input information generation unit 14 may configure input information with the words wd acquired from the utterance history. Moreover, the input information generation unit 14 may, from each of a plurality of given amounts of utterance history including the keyword kw related to the item, acquire words by the method described with reference to FIG. 5, and configure input information based on a predetermined number of words having the highest frequency of occurrence within the acquired words.

Moreover, a method for generating input information is not limited to the examples described above and the input information generation unit 14 may generate input information based, for example, on action history information indicating a behavior history of the user's avatar in the virtual space. The input information generation unit 14 may extract, from the action history information, information related to the item according to a given extraction criterion, and generate input information based on the extracted information.

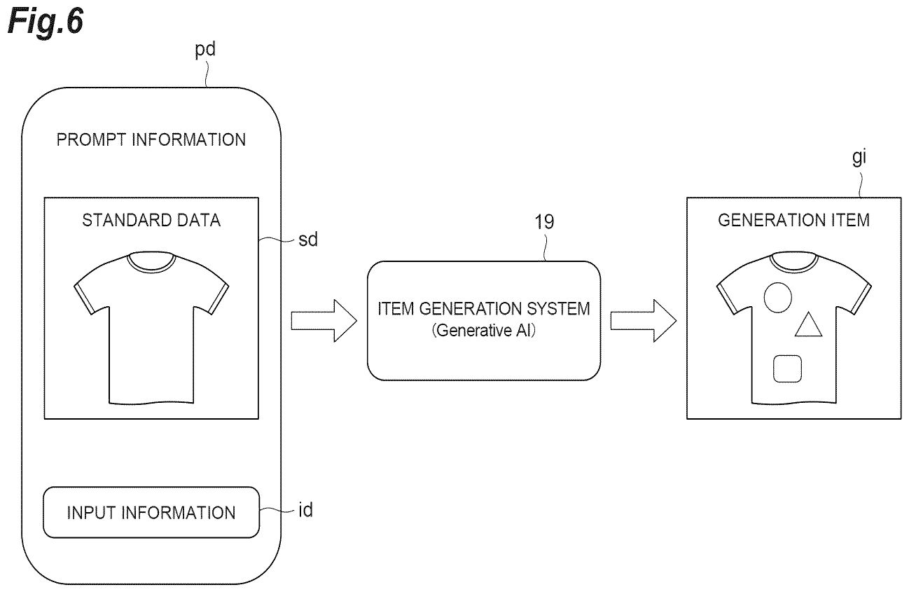

The prompt output unit 15 outputs the standard data and the input information as prompt information to be input to the item generation system. FIG. 6 is a diagram schematically showing the generation of a generation item by the item generation system. Specifically, as illustrated in FIG. 6, the prompt output unit 15 configures prompt information pd based on the standard data sd acquired by the standard data acquisition unit 13 and the input information id generated by the input information generation unit 14, and inputs the configured prompt information pd to the item generation system 19.

The item generation system 19 generates a generation item gi in accordance with an input of the prompt information pd. The generation item gi is an item configured based on the standard data in accordance with the input information. The item generation system 19 may include so-called generative AI. The generative AI is generally a large-scale machine learning model constructed by deep learning using large amounts of data and content, and outputs images, text, and the like based on an input prompt.

In the present embodiment, the item generation system 19 outputs a generation item that is an item having features applied according to the input information to the item represented by the standard data, in accordance with the input of the standard data constituting the shape of the item and prompt information configured from input information unique to the user. More specifically, as shown in FIG. 6, the item generation system 19 of the present embodiment outputs, as the generation item gi, clothing in which elements such as colors and patterns according to the input information id are applied to clothing whose shape is defined by the standard data sd.

The generation item gi output by the item generation system 19 as described above may include, at least in part, a color not included in the standard data sd input to the item generation system 19 as the item configuration. Also, the generation item may be configured as point cloud data, similar to the standard data.

The item possession unit 16 associates the generation item generated by the item generation system 19 with the user. Specifically, the item possession unit 16 acquires the generation item from the item generation system 19 and causes the generation item storage unit 24 to store the acquired generation item in association with the user.

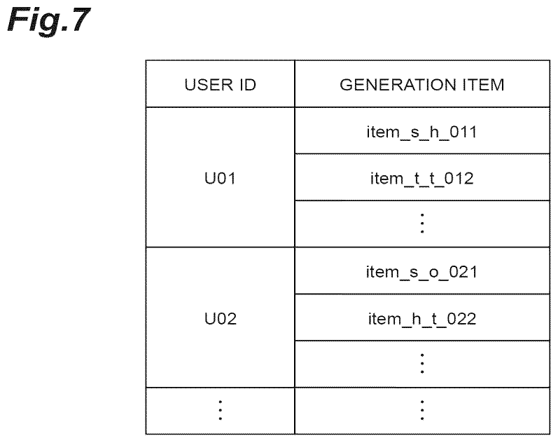

FIG. 7 is a diagram schematically showing the configuration of the generation item storage unit 24 and the generation items stored therein. As shown in FIG. 7, the generation item storage unit 24 stores data constituting a generation item in association with a user ID for identifying the user. For example, the item possession unit 16 causes the generation item storage unit 24 to store data “item_s_h_011” constituting the generation item in association with user ID “U01” of the user who issued the generation instruction.

Also, the item possession unit 16 may cause the prompt information on which the generation item is based to be stored instead of causing the generation item storage unit 24 to store the generation item. In this case, the prompt output unit 15 may input the prompt information stored as an aspect of the generation item in the generation item storage unit 24 to the item generation system 19 configured as the latest generative AI, so that the generation item can be generated each time.

The item possession unit 16 may receive a sharing designation for a generation item associated with a second user different from a first user from the first user among a plurality of users and may associate the generation item of the sharing designation with the first user as a shared item.

Specifically, if an example is described with reference to FIG. 7, when the user with user ID “U01” desires to share a generation item possessed by the user with user ID “U02,” the item possession unit 16 may receive a sharing designation for, for example, generation item “item_s_o_021” among the generation items associated with user ID “U02” from the terminal T (or the avatar) of the user with user ID “U01.”

When such a sharing designation has been received, the item possession unit 16 may associate the generation item “item_s_o_021” with user ID “U01” as a shared item. Thereby, the avatar of the user with user ID “U01” can use, in the virtual space, the generation item “item_s_o_021” generated in accordance with the unique information of the user with user ID “U02.”

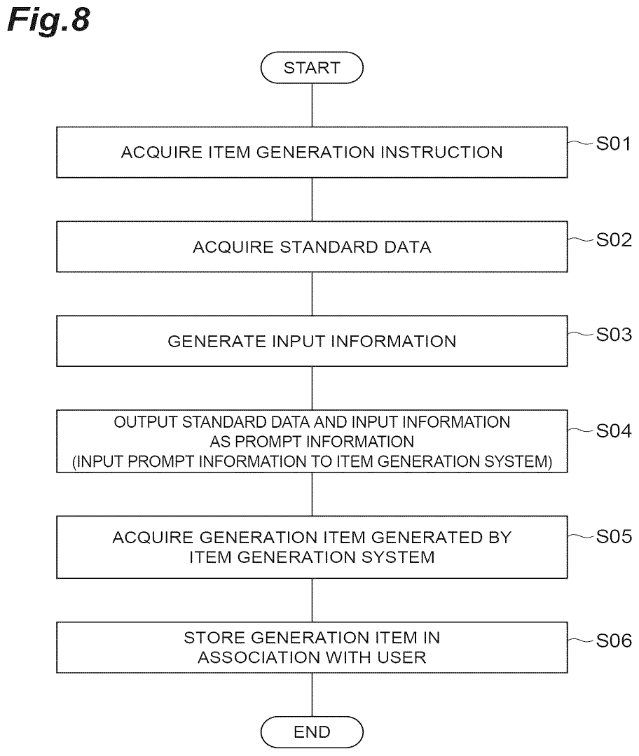

FIG. 8 is a flowchart showing processing content of the item providing method in the item providing system 10A.

In step S1, the instruction acquisition unit 12 acquires a generation instruction for an item from the user. In step S2, the standard data acquisition unit 13 acquires standard data constituting the item indicated in the type information of the item included in the generation instruction from the standard data storage unit 21.

In step S3, the input information generation unit 14 generates input information including information extracted according to a given extraction criterion from user information unique to the user.

In step S4, the prompt output unit 15 outputs the standard data and the input information as prompt information to be input to the item generation system 19. That is, the prompt output unit 15 inputs the prompt information to the item generation system 19.

In step S5, the item possession unit 16 acquires the generation item generated by the item generation system 19. Also, in step S6, the item possession unit 16 causes the generation item storage unit 24 to store the generation item in association with the user.

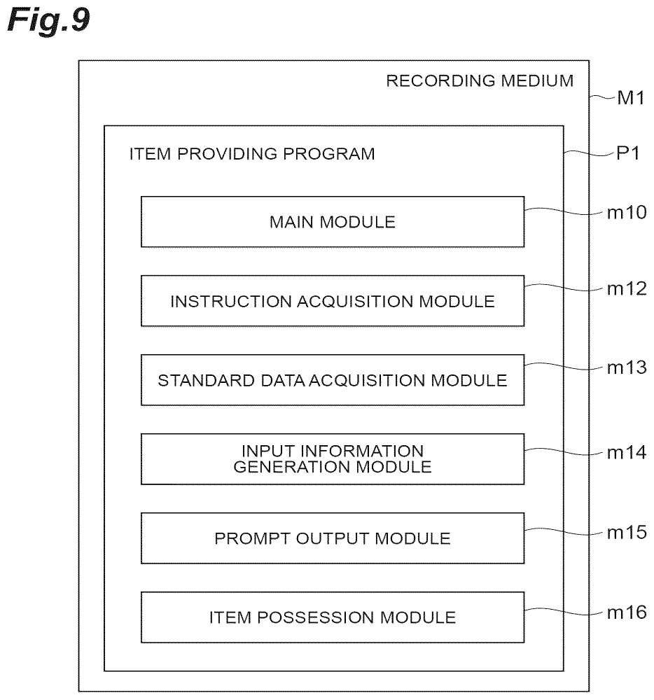

Next, an item providing program for causing a computer to function as the item providing system 10A of the present embodiment will be described with reference to FIG. 9. FIG. 9 is a diagram showing a configuration of the item providing program. An item providing program P1 is configured to include a main module m10 that integrally controls an item providing process in the item providing system 10A, an instruction acquisition module m12, a standard data acquisition module m13, an input information generation module m14, a prompt output module m15, and an item possession module m16. The functions for the functional units 12 to 16 are implemented by the corresponding modules m12 to m16.

An aspect in which the item providing program P1 is transmitted via a transmission medium such as a communication line may be provided or an aspect in which the item providing program P1 is stored in a recording medium M1 as exemplified in FIG. 9 may be provided.

According to the item providing system 10A, the item providing method, and the item providing program P1 of the present embodiment described above, input information id to be input to the item generation system 19 is generated based on user information. Because the user information is information unique to the user, the input information id is also information unique to the user. Because the generated input information id and standard data sd are output as prompt information pd to be input to the item generation system 19, the item generation system 19 can generate a generation item gi. By associating the generation item gi with the user, it is possible to provide the user's avatar with the generation item gi unique to that user.

The item providing system according to the present disclosure may have the following configuration. Moreover, the operations and effects of each configuration will be described below.

An item providing system according to an aspect of the present disclosure is an item providing system for providing items to be possessed, used, and/or utilized by a user in a virtual space, the item providing system comprising: an instruction acquisition unit configured to acquire a generation instruction for the items from the user, the generation instruction including type information indicating an item type; a standard data acquisition unit configured to acquire previously stored standard data constituting an item indicated in the type information; an input information generation unit configured to generate input information including information extracted from user information unique to the user, associated with the user, according to a given extraction criterion; a prompt output unit configured to output prompt information for inputting the standard data and the input information to an item generation system, the item generation system generating a generation item that is an item configured based on the standard data in accordance with the input information, in accordance with an input of the prompt information; and an item possession unit configured to associate the generation item generated by the item generation system with the user.

According to the above-described aspect, the input information to be input to the item generation system is generated based on user information. Because the user information is unique to the user, the input information is also unique to the user. Because the generated input information and the standard data are output as the prompt information to be input to the item generation system, the item generation system can generate the generation item. By associating the generation item with the user, it is possible to provide the user's avatar with an item unique to that user.

Moreover, in the item providing system according to another aspect, the standard data is associated with each region in the virtual space, and the standard data acquisition unit may acquire the standard data associated with the user's location in the virtual space.

According to the above aspect, standard data pre-associated with the region in which the user is located is output as prompt information to be input to the item generation system. Accordingly, it is possible to provide the user with a generation item unique to the region in which the user is located.

Moreover, in the item providing system according to another aspect, the user information may include utterance history information, which is a history of the user's utterances in the virtual space, and the input information generation unit may generate the input information based on the utterance history information, using the extraction of related words, which are set in advance as words related to the item, as the extraction criterion.

According to the above-described aspect, because the input information includes words included in the user's utterance history, it is possible to output information unique to the user as prompt information.

Moreover, in the item providing system according to another aspect, the user information may include user attribute information indicating attributes of the user, and the input information generation unit may generate the input information including the attribute information extracted from the user attribute information, using the extraction of attribute information of a predetermined attribute item among a plurality of attribute items included in the user attribute information as the extraction criterion.

According to the above-described aspect, because the input information includes predetermined attribute information within the user attribute information, it is possible to output information unique to the user as prompt information.

Moreover, in the item providing system according to another aspect, the item possession unit may receive, from a first user among a plurality of users, a sharing designation for the generation item associated with a second user different from the first user, and associate the generation item of the sharing designation as a shared item with the first user.

According to the above-described aspect, when the sharing designation from the first user for the generation item generated and possessed by the second user is received, the generation item is associated with the first user. Thereby, it is possible to configure the system so that the first user can use the generation item like the second user. Accordingly, it is possible to share a generation item of the second user with the first user.

Moreover, in the item providing system according to another aspect, the standard data may be data constituting a shape of the item, and the generation item may have, at least in part, a color not included in a configuration of the item as defined by the standard data input to the item generation system.

According to the above-described aspect, it is possible to acquire a generation item that reflects user-specific characteristics in the item represented by the standard data.

Moreover, in the item providing system according to another aspect, the item may be clothing that the user's avatar can wear in the virtual space.

According to the above-described aspect, it is possible to provide clothing items unique to the user for the avatar to wear.

Also, the block diagram shown in FIG. 1 shows blocks of functional units. Those functional blocks (constituent elements) can be implemented by any combination of at least one of hardware and software. Moreover, a method for implementing each functional block is not particularly limited. That is, each functional block may be implemented by one device coupled physically or logically or two or more devices separated physically or logically may be directly or indirectly connected (e.g., in a wired or wireless manner) to each other and each functional block may be realized by these plural devices. The functional blocks may be implemented by combining software with the above-described one or more devices.

Functions include determining, deciding, judging, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating (mapping), assigning, and the like, but the functions are not limited thereto. For example, a functional block (constituent element) performing the transmitting function may be referred to as a transmitting unit or a transmitter. For any of the above, as described above, the implementation method is not particularly limited to any one method.

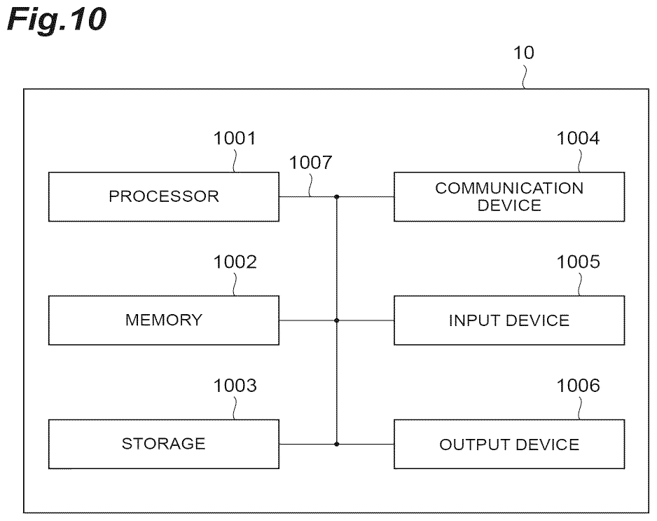

For example, the item providing system 10A according to an embodiment of the present invention may function as a computer. FIG. 10 is a diagram showing an example of a hardware configuration of the item providing system 10A according to the present embodiment. Physically, the item providing system 10A may be configured as a computer device including a processor 1001, a memory 1002, a storage 1003, a communication device 1004, an input device 1005, an output device 1006, a bus 1007, and the like.

Also, in the following description, the term “device” may be interpreted as a circuit, unit, or the like. The hardware configuration of the item providing system 10A may include one or more of the devices shown in FIG. 9, or may be configured without including some of those devices.

Various functions of the item providing system 10A are implemented when the processor 1001 performs computing by loading a predetermined software (computer program) onto hardware such as the processor 1001 and the memory 1002, controls communication via the communication device 1004, and controls reading and/or writing of data on the memory 1002 and the storage 1003.

The processor 1001, for example, operates an operating system to control the entire computer. The processor 1001 may include a central processing unit (CPU) including an interface with a peripheral device, a control device, a computing device, a register, and the like. For example, the functional units 12 to 16 shown in FIG. 1 may be implemented by the processor 1001.

Moreover, the processor 1001 reads a computer program (computer program code), a software module, data, from the storage 1003 and/or the communication device 1004 into the memory 1002, and executes various types of processing according to these. As the program, a program that is capable of executing on the computer at least a part of the operation described in the above embodiments is used. For example, functional units 12 to 16 of the item providing system 10A may be stored in the memory 1002 and implemented by a control program operating on the processor 1001. Although the case where the various types of processing described above are executed by one processor 1001 has been described, the various types of processing may be executed simultaneously or sequentially by two or more processors 1001. The processor 1001 may be implemented by using one or more chips. Also, the program may be transmitted from a network via a telecommunication line.

The memory 1002 is a computer-readable recording medium, and may include, for example, at least one of a read only memory (ROM), an erasable programmable ROM (EPROM), an electrically erasable programmable ROM (EEPROM), and a random-access memory (RAM). The memory 1002 may also be referred to as a register, a cache, a main memory (a main storage device), or the like. The memory 1002 is capable of storing programs (program codes), software modules, and the like capable of being executed to perform an item providing method according to an embodiment of the present invention.

The storage 1003 is a computer-readable storage medium, and may include, for example, at least one of an optical disc, such as a compact disc ROM (CD-ROM), a hard disk drive, a flexible disk; an optical magnetic disk (e.g., a compact disc, a digital versatile disc, or a Blu-ray (registered trademark) disc), a smart card; a flash memory (e.g., a card, a stick, or a key drive), a floppy (registered trademark) disk, a magnetic strip, or the like. The storage 1003 may be referred to as an auxiliary memory device. The above-described storage medium may be, for example, a database including the memory 1002 and/or the storage 1003, a server, or another suitable medium.

The communication device 1004 is hardware (a transceiver device) for performing communication between computers via a wired network and/or a wireless network, and is also referred to, for example, as a network device, a network control unit, a network card, a communication module, or the like.

The input device 1005 is an input device (e.g., a keyboard, a mouse, a microphone, a switch, a button, a sensor, or the like) that receives an external input. The output device 1006 is an output device (e.g., a display, a speaker, an LED lamp, or the like) that externally provides an output. Also, the input device 1005 and the output device 1006 may have an integrated configuration (e.g., a touch panel).

Moreover, the devices such as the processor 1001 and the memory 1002 are connected to each other via the bus 1007 for communication of information. The bus 1007 may be configured using a single bus, or may be configured using different buses between devices.

Moreover, the item providing system 10A may be configured to include hardware such as a microprocessor, a digital signal processor (DSP), an application-specific integrated circuit (ASIC), a programmable logic device (PLD), and a field programmable gate array (FPGA), and some or all functional blocks may be implemented by the hardware. For example, the processor 1001 may be implemented by at least one of these hardware components.

Notification of information is not limited to that described in the above aspect/embodiment, and may be performed by using a different method. For example, the notification of information may be performed by physical layer signaling (e.g., downlink control information (DCI), uplink control information (UCI), upper layer signaling (e.g., RRC signaling, medium access control (MAC) signaling, broadcasting information (master information block (MIB), system information block (SIB))), other signals, or a combination of these. Moreover, the RRC signaling may be called RRC message or can be, for example, RRC connection setup message, RRC connection reconfiguration message, or the like.

Each of the above aspects/embodiments described in the present disclosure may be applied to at least one of long term evolution (LTE), LTE-advanced (LTE-A), SUPER 3G, IMT-Advanced, 4th generation mobile communication system (4G), 5th generation mobile communication system (5G), future radio access (FRA), new radio (NR), W-CDMA (Registered Trademark), GSM (Registered Trademark), CDMA 2000, ultra mobile broadband (UMB), IEEE 802.11 (Wi-Fi (Registered Trademark)), IEEE 802.16 (WiMAX (Registered Trademark)), IEEE 802.20, ultra-wideband (UWB), Bluetooth (Registered Trademark), a system using any other appropriate system, and a next-generation system that is expanded based thereon. Moreover, a combination of a plurality of systems (e.g., a combination of at least one of the LTE and the LTE-A with the 5G or the like) may be applied.

The processing procedure, sequence, flowchart, and the like of the aspects/embodiments described in the present disclosure may be performed in a different order as long as no contradiction is incurred. For example, for a method described in the present disclosure, elements of various steps are described in illustrative order, and the order is not limited to the described specific order.

The specific operation that is performed by the base station in the present disclosure may be performed by its upper node in some cases. In a network including one or more network nodes having a base station, it is obvious that the various operations performed for communication with the terminal may be performed by at least one of the base station and other network nodes other than the base station (e.g., MME, S-GW, and the like may be considered, but not limited thereto). Although an example in which there is one network node other than the base station is described above, a combination of a plurality of other network nodes (e.g., MME and S-GW) may be used.

Information and the like can be output from an upper layer (or lower layer) to a lower layer (or upper layer). Information and the like may be input and output via a plurality of network nodes.

Input or output information and the like may be stored in a predetermined location (e.g., a memory) or may be managed using a management table. Input or output information and the like can be overwritten or updated, or information may be added thereto. Output information and the like may be deleted. Input information and the like may be transmitted to another device.

Determination may be made by a value represented by one bit (0 or 1), may be made by a Boolean value (Boolean: true or false), or may be made by comparison of numerical values (e.g., comparison with a predetermined value).

Each aspect/embodiment described in the present disclosure may be used alone; may be combined to be used; or may be switched in accordance with execution. Moreover, the notification of predetermined information (e.g., the notification indicating that “it is X”) is not limited to the notification that is made explicitly; and the notification may be made implicitly (e.g., the notification of the predetermined information is not performed).

Although the present disclosure has been described in detail above, it is obvious to those skilled in the art that the present disclosure is not limited to the embodiments described in the present disclosure. The present disclosure can be practiced with modifications and variations without departing from the spirit and scope of the present disclosure as defined by the claims. Accordingly, the description of the present disclosure is for illustrative purposes and is not meant to be limiting in any way.

Regardless of whether software is referred to as software, firmware, middleware, microcode, hardware description language, or another name, the software should be interpreted broadly so as to imply a command, a command set, a code, a code segment, a program code, a program, a subprogram, a software module, an application, a software application, a software package, a routine, a subroutine, an object, an executable file, an execution thread, a procedure, a function, and the like.

Moreover, software, a command, information, and the like may be transmitted and received via a transmission medium. For example, when the software is transmitted from a Web site, a server, or another remote source using at least one of wired technology (such as a coaxial cable, an optical fiber cable, a twisted pair, and a digital subscriber line (DSL)) and wireless technology (such as infrared, microwave, and the like), at least one of the wired technology and wireless technology is included within the definition of the transmission medium.

Information, signals, or the like described in the present disclosure may be represented by using any of a variety of different technologies. For example, data, an instruction, a command, information, a signal, a bit, a symbol, a chip, or the like that may be described throughout the above description may be represented by a voltage, a current, electromagnetic waves, a magnetic field, a magnetic particle, an optical field, photons, or a desired combination thereof.

The terms described in the present disclosure and/or terms necessary for understanding the present disclosure may be replaced by terms having the same or similar meanings.

The terms “system” and “network” used in the present disclosure are used interchangeably.

Moreover, the information, parameters, and the like, which are described in the present disclosure, may be represented by absolute values, may be represented as relative values from predetermined values, or may be represented by any other corresponding information. For example, a radio resource may be indicated by an index.

The name used for the above parameter is not a restrictive name in any respect. Furthermore, formulas and the like using these parameters may be different from those explicitly disclosed in the present disclosure. Because the various channels (e.g., PUCCH, PDCCH, or the like) and information element can be identified by any suitable name, the various names assigned to these various channels and information elements shall not be restricted in any way

Terms such as “determining” and “deciding” used in the present disclosure may include various operations of various types. For example, “determining” and “deciding” may include deeming that a result of judging, calculating, computing, processing, deriving, investigating, looking up, search, and inquiry (e.g., search in a table, a database, or another data structure), or ascertaining is determined or decided. Moreover, “determining” and “deciding” may include, for example, deeming that a result of receiving (e.g., reception of information), transmitting (e.g., transmission of information), input, output, or accessing (e.g., accessing data in memory) is determined or decided. Moreover, “determining” and “deciding” may include deeming that a result of resolving, selecting, choosing, establishing, or comparing is determined or decided. In other words, “determining” and “deciding” may include deeming that some operation is determined or decided. Moreover, “determining (deciding)” may be read as “assuming,” “expecting,” “considering,” or the like.

The expression “based on” used in the present specification does not mean “based on only” unless otherwise stated particularly. In other words, the expression “based on” means both “based on only” and “based on at least.”

Any reference to elements using names, such as “first” and “second,” which are used in the present disclosure, does not generally limit the quantity or order of these elements. These names can be used in the present disclosure as a convenient method for distinguishing two or more elements. Accordingly, the reference to the first and second elements does not imply that only the two elements can be adopted here, or does not imply that the first element must precede the second element in any way.

The term “means” in the configuration of each device described above may be replaced with a term such as “unit,” “circuit,” or “device.”

As long as “include,” “including,” and the variations thereof are used in the present disclosure, these terms are intended to be inclusive, similar to the term “comprising.” Furthermore, it is intended that the term “or” used in the present disclosure or the claims is not “exclusive OR.”

In the present disclosure, for example, if articles, such as a, an, and the in English, are added according to translation, the present disclosure may include that the nouns following these articles have plural forms.

In the present disclosure, the term “A and B are different” may mean “A and B are different from each other.” The term may also mean that “A and B are different from C.” The terms such as “separate,” “coupled,” and the like may also be interpreted like the term “different.”

The item providing system 10A of the present disclosure may have the following configurations.

[1] An item providing system for providing items to be possessed, used, and/or utilized by a user in a virtual space, the item providing system comprising:
an instruction acquisition unit configured to acquire a generation instruction for the items from the user, the generation instruction including type information indicating an item type;
a standard data acquisition unit configured to acquire previously stored standard data constituting an item indicated in the type information;
an input information generation unit configured to generate input information including information extracted from user information unique to the user, associated with the user, according to a given extraction criterion;
a prompt output unit configured to output prompt information for inputting the standard data and the input information to an item generation system, the item generation system generating a generation item that is an item configured based on the standard data in accordance with the input information, in accordance with an input of the prompt information; and
an item possession unit configured to associate the generation item generated by the item generation system with the user.

[2] The item providing system according to [1],
wherein the standard data is associated with each region in the virtual space, and
wherein the standard data acquisition unit acquires the standard data associated with the user's location in the virtual space.

[3] The item providing system according to [1] or [2],
wherein the user information includes utterance history information, which is a history of the user's utterances in the virtual space, and
wherein the input information generation unit generates the input information based on the utterance history information, using the extraction of related words, which are set in advance as words related to the item, as the extraction criterion.

[4] The item providing system according to any one of [1] to [3],
wherein the user information includes user attribute information indicating attributes of the user, and
wherein the input information generation unit generates the input information including the attribute information extracted from the user attribute information, using the extraction of attribute information of a predetermined attribute item among a plurality of attribute items included in the user attribute information as the extraction criterion.

[5] The item providing system according to any one of [1] to [4], wherein the item possession unit receives, from a first user among a plurality of users, a sharing designation for the generation item associated with a second user different from the first user, and associates the generation item of the sharing designation as a shared item with the first user.

[6] The item providing system according to any one of [1] to [5],
wherein the standard data is data constituting a shape of the item, and
wherein the generation item has, at least in part, a color not included in a configuration of the item as defined by the standard data input to the item generation system.

[7] The item providing system according to any one of [1] to [6], wherein the item is clothing that the user's avatar can wear in the virtual space.

### REFERENCE SIGNS LIST

1 Virtual space management system, 10 Virtual space management device, 10A Item providing system, 11 Virtual space control unit, 12 Instruction acquisition unit, 13 Standard data acquisition unit, 14 Input information generation unit, 15 Prompt output unit, 16 Item possession unit, 19 Item generation system, 21 Standard data storage unit, 22 User attribute information storage unit, 23 Utterance history information storage unit, 24 Generation item storage unit, M1 Recording medium, m10 Main module, m12 Instruction acquisition module, m13 Standard data acquisition module, m14 Input information generation module, m15 Prompt output module, m16 Item possession module, P1 Item providing program, pd Prompt information, sd Standard data, id Input information, gi Generation item

1. An item providing system for providing items to be possessed, used, and/or utilized by a user in a virtual space, the item providing system comprising circuitry configured to:
acquire a generation instruction for the items from the user, the generation instruction including type information indicating an item type;
acquire previously stored standard data constituting an item indicated in the type information;
generate input information including information extracted from user information unique to the user, associated with the user, according to a given extraction criterion;
output prompt information for inputting the standard data and the input information to an item generation system, the item generation system generating a generation item that is an item configured based on the standard data in accordance with the input information, in accordance with an input of the prompt information; and
associate the generation item generated by the item generation system with the user.

2. The item providing system according to claim 1,
wherein the standard data is associated with each region in the virtual space, and
wherein the circuitry acquires the standard data associated with the user's location in the virtual space.

3. The item providing system according to claim 1,
wherein the user information includes utterance history information, which is a history of the user's utterances in the virtual space, and
wherein the circuitry generates the input information based on the utterance history information, using the extraction of related words, which are set in advance as words related to the item, as the extraction criterion.

4. The item providing system according to claim 1,
wherein the user information includes user attribute information indicating attributes of the user, and
wherein the circuitry generates the input information including the attribute information extracted from the user attribute information, using the extraction of attribute information of a predetermined attribute item among a plurality of attribute items included in the user attribute information as the extraction criterion.

5. The item providing system according to claim 1, wherein the circuitry receives, from a first user among a plurality of users, a sharing designation for the generation item associated with a second user different from the first user, and associates the generation item of the sharing designation as a shared item with the first user.

6. The item providing system according to claim 1,
wherein the standard data is data constituting a shape of the item, and
wherein the generation item has, at least in part, a color not included in a configuration of the item as defined by the standard data input to the item generation system.

7. The item providing system according to claim 1, wherein the item is clothing that the user's avatar can wear in the virtual space.
